(19) United States
(12) Patent Application Publication
(10) Pub. No.: US 2006/0181047 A1
(43) Pub. Date: Aug. 17, 2006

(54) Trailing arm for a vehicle suspension

(76) Inventors: Michael A. Chamberlin, Richland, MI (US); C. Michael Smith, Portage, MI (US); Allen Peacock, Kalamazoo, MI (US); Andrew Power, Kalamazoo, MI (US); Kent E. Davison, Sturgis, MI (US)

Correspondence Address: MARSHALL & MELHORN, FOUR SEAGATE, EIGHT FLOOR, TOLEDO, OH, 43604, US

(21) Appl. No.: 11/092,957

(22) Filed: Mar. 29, 2005

Related U.S. Application Data
(63) Continuation-in-part of application No. 11/057,581, filed on Feb. 14, 2005, now abandoned.

(51) Int. Cl. B60G 3/12

(52) U.S. Cl. 280/124.128

(57) ABSTRACT

A trailing arm has a first side portion with an axle recess and a second side portion with an axle recess. An upper portion of the trailing arm is defined at least partially by overlapping portions of the first side portion and the second side portion. The overlapping portions define a weld aperture in the upper portion and a suspension aperture.

### RELATED APPLICATION

This application is a continuation-in-part of application Ser. No. 11/057,581, filed on Feb. 14, 2005. The application Ser. No. 11/057,581 is incorporated herein by reference.

### FIELD OF THE INVENTION

The present invention relates to a trailing arm for a vehicle suspension. The present invention also relates to a trailing arm system for a vehicle suspension.

### BACKGROUND OF THE INVENTION

Trailing arms for vehicle suspension systems, such as trailer suspension systems, are well-known to those skilled in the art. Different designs which claim various advantages over one another are prevalent in the industry. For example, U.S. Pat. Nos. 5,037,126, 5,366,237, 5,375,871, 5,690,353, 6,322,089, 6,039,336, 6,209,895 B1, and 6,827,360 B2 teach various trailing arm designs.

The prior art trailing arms, however, suffer from several disadvantages. For example, the prior art designs are often heavy and/or lack sufficient durability to withstand extended use. The prior art designs also utilize a large weldments for connection to the axle, particularly in the areas of high torsional loading. The prior art designs also often did not interface efficiently with the other structures on the axle such as shocks, airsprings, and braking system.

In light of the disadvantages of the prior art, it would be advantageous to have a trailing arm that is lightweight and that has good durability. It would also be advantageous to reduce the weldment required between the axle and the trailing arm. Additionally, it would be advantageous to have a trailing arm that interfaced efficiently with the other structures on the axle.

### SUMMARY OF THE INVENTION

The present invention is a trailing arm having a first side portion having an axle recess at one end and a second side portion having an axle recess at one end. An upper portion of the trailing arm is defined at least partially by overlapping portions of the first side portion and the second side portion. The overlapping portions define a weld aperture in the upper portion. The upper portion has a suspension aperture therethrough.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a perspective view of a trailing arm and a saddle bracket of the present invention;

FIG. 2 is a perspective view of another embodiment of the trailing arm shown in FIG. 1 and a saddle bracket;

FIG. 3 is a perspective view of another embodiment of a trailing arm of the present invention and a saddle bracket;

FIG. 4 is a perspective view of another embodiment of the trailing arm shown in FIG. 3 and a saddle bracket;

FIG. 5 is a perspective view of another embodiment of the trailing arms shown in FIGS. 3 and 4 and a saddle bracket;

FIG. 6 is a perspective, exploded view of two trailing arms, two saddle brackets, two bushings and an axle of the present invention;

FIG. 7 is an upper perspective, assembled view of the two trailing arms, the two saddle brackets, two bushings and the axle of FIG. 6;

FIG. 8 is a top view of the two trailing arms, the two saddle brackets and the axle of FIG. 7;

FIG. 9 is a top view of the trailing arms depicted in FIG. 3, two saddle brackets and the axle in an assembled state;

FIG. 10 is a lower perspective, assembled view of the two trailing arms, the two saddle bracket, two bushings and the axle of FIG. 8;

FIG. 11 is a perspective view of a vehicle frame having a suspension system of the present invention installed thereon;

FIG. 12 is a perspective view depicting an alternative embodiment of the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

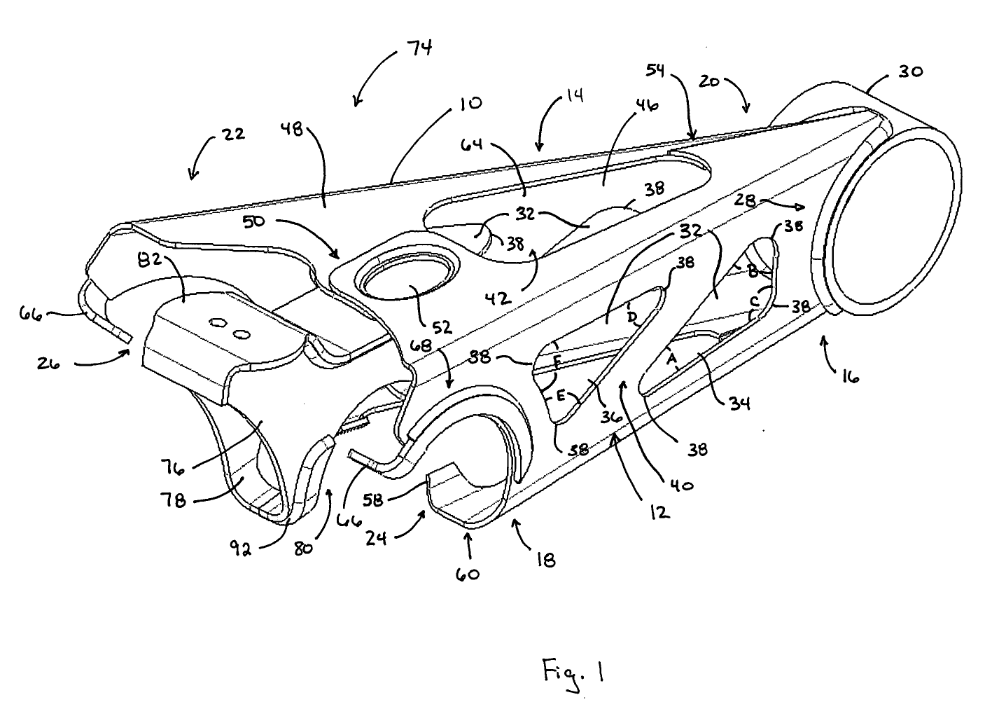

FIG. 1 depicts a trailing arm 10 of the present invention. The trailing arm 10 preferably is comprised of a first side portion 12 and a second side portion 14. It should be appreciated that the first side portion 12 is separately formed from the second side portion 14. It should also be appreciated that the first side portion 12 can be integrally formed with the second side portion 14, as described in greater detail below. Preferably, the first side portion 12 is separately formed from the second side portion 14.

The first side portion 12 has a forward end 16 and a trailing end 18 and the second side portion 14 has a forward end 20 and a trailing end 22. In the preferred embodiment, the trailing end 18 of the first side portion 12 defines an axle recess 24 and the trailing end 22 of the second side portion 14 defines an axle recess 26. The forward end 16 of the first side portion 12 defines a curvilinear surface 28 for a pivot connection 30 and the forward end 20 of the second side portion 14 defines a curvilinear surface (not shown) for the same pivot connection 30. More preferably, the pivot connection 30, such as a bushing housing, is secured to the curvilinear surfaces 28 of the forward ends 16, 20 of the first side portion 12 and the second side portion 14.

Preferably, the first side portion 12 and the second side portion 14 each have at least one aperture, as shown in FIG. 1. Those skilled in the art will appreciate that the removal of the material that existed in the place of the at least one aperture lightens the side portions 12, 14 and thus the trailing arm 10.

The at least one aperture may be of any shape, size or number. In the preferred embodiment depicted in FIG. 1, there are two apertures in each side portion 12, 14, and all of the apertures in the side portions 12, 14 are triangularly shaped. The apertures on both side portions 12, 14 will be generally designated reference number 32.

Looking now at a first 34 of the two triangularly shaped apertures 32 in the first side portion 12, it can be seen that it has internal angles A, B and C. The angles A, B, and C can be the same, however, it is preferred that at least two of the angles differ from one another. In a more preferred embodiment, the angles A, B, and C are all different from one another.

A second triangularly shaped aperture 36 on the first side portion 12 has internal angles D, E, F that may be identical to angles A, B and C, or they may be different. The triangularly shaped apertures 32 on the second side portion 14 may be identical to those on the first side portion 12 or they may have different internal angles.

As shown in FIG. 1, it is preferred that the corners 38 of the triangularly shaped apertures 32 that form the angles A, B, C or D, E, F are corners 38 with radiuses. Those skilled in the art will appreciate, however, that the corners 38 need not have radiuses. The radiuses of the corners 38 may be the same or they may differ from one another.

The apertures 32 are preferably separated on the first side portion 12 by a length of material. Preferably, the apertures 32 on the first side portion 12 are separated by a diagonal 40. The apertures 32 on the second side portion 14 are also separated by a length of material. Preferably, the apertures 32 on the second side portion 14 are separated by a diagonal 42. As shown in FIG. 1, the diagonals 40, 42 extend downwardly from the forward ends 16, 20.

Those skilled in the art will appreciate that the apertures 32 on either side portion 12 or 14 can be separated by any shape, size or length of material running in any direction.

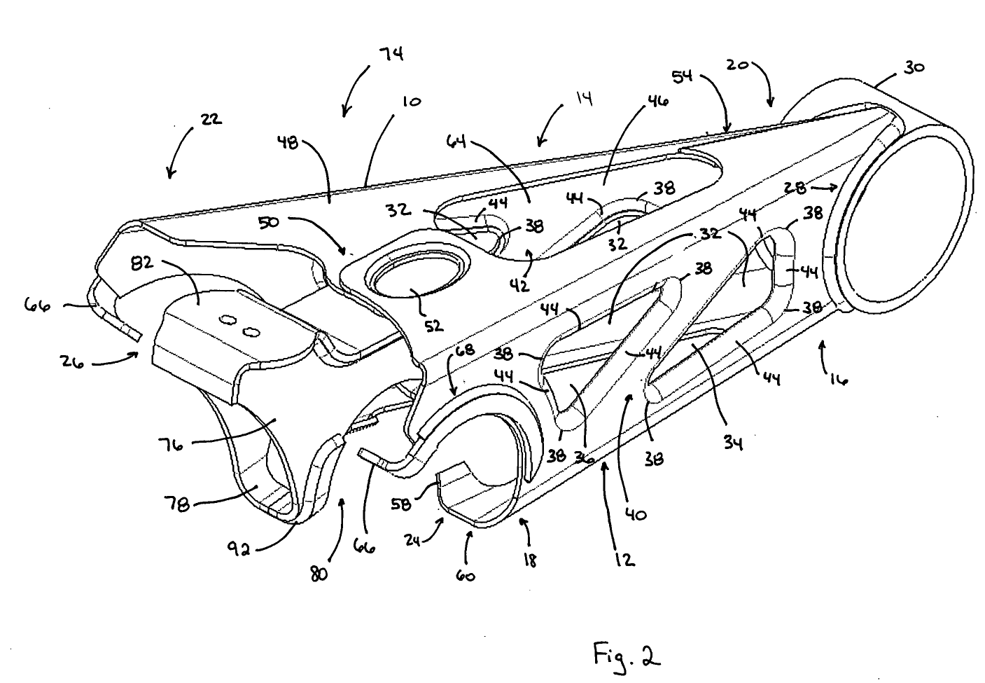

FIG. 2 depicts an alternative embodiment of the present invention wherein the edges of the apertures are rolled to form a return 44 that extends inwardly to an interior portion 46 of the trailing arm 10. Those skilled in the art will appreciate that the return 44 about the apertures 32 in the first and second side portions 12, 14 add high strength, stiffness and thus durability to the side portions 12, 14.

Referring to both FIGS. 1 and 2, an upper portion 48 of the trailing arm 10 is defined, at least partially, by overlapping the first side portion 12 and the second side portion 14. A preferred embodiment of the side portions 12, 14 to form the upper portion 48 are C-shaped side portions 12, 14.

Preferably, the first side portion 12 and the second side portion 14 overlap in a rearward portion of the upper portion 48 of the trailing arm 10, called hereinafter a rearward overlap portion 50. In a more preferred embodiment, a weld aperture 52 is located in the rearward overlap portion 50. Overlapping the first side portion 12 and the second side portion 14 in the rearward overlap portion 50 adds high strength, stiffness and durability to the material about the weld aperture 52 and the trailing arm 10 overall.

The first side portion 12 and the second side portion 14 also preferably overlap in a forward portion of the upper portion 54 of the trailing arm 10, called hereinafter a forward upper overlap portion 54. Overlapping the first side portion 12 and the second side portion 14 in the forward overlap upper portion 54 adds high strength, stiffness and durability to the trailing arm 10.

As shown in FIGS. 1 and 2, the first side portion 12 preferably overlaps the second side portion 14, as described above. Those skilled in the art will appreciate that the second side portion 14 can overlap the first side portion 12 without departing from the scope of the present invention.

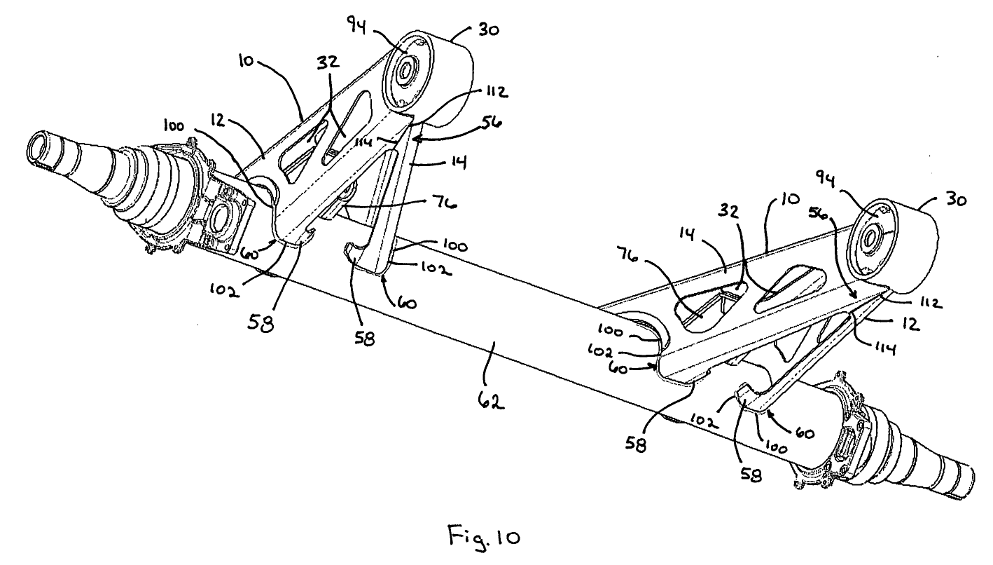

As best seen in FIG. 10, it is also preferred that the first side portion 12 and the second side portion 14 abut one another at a forward lower portion of the trailing arm 10, hereinafter called the forward lower abutting portion 56.

The preferred embodiment of the invention also includes providing at least one return on a lower portion of the axle recess of at least one of the side portions 12, 14. More preferably, as depicted in both FIGS. 1 and 10, a return 58 is provided on the lower portion 60 of the axle recesses 24, 26 on the first side portion 12 and the second side portion 14. The returns 58 preferably have a complementary shape to an axle 62.

Preferably, the upper portion 50 also defines a suspension aperture 64 therein, as seen in both FIGS. 1 and 2. The suspension aperture 64 may be of any size or shape and it within the scope of the present invention to have one or more apertures 64 in the upper portion 48. In the preferred embodiment, the suspension aperture 64 is triangular in shape, however, other shapes such as oval, rectangular and circular are within the scope of the present invention.

In an embodiment of the present invention which is not depicted in the Figures, the suspension aperture 64 has edges that are rolled to form a return that extends inwardly to the interior portion 46 of the trailing arm 10.

At least one extension plate is preferably attached to an upper portion of the axle recess on at least one of the side portions. In a more preferred embodiment, an extension plate 66 is attached to an upper portion 68 of the axle recesses 24, 26 on both of the side portions 12, 14, as shown in FIGS. 1 and 2. The extension plates 66 and the axle recesses 24, 26 of both of the side portions 12, 14 preferably have a complementary shape to the axle (not shown).

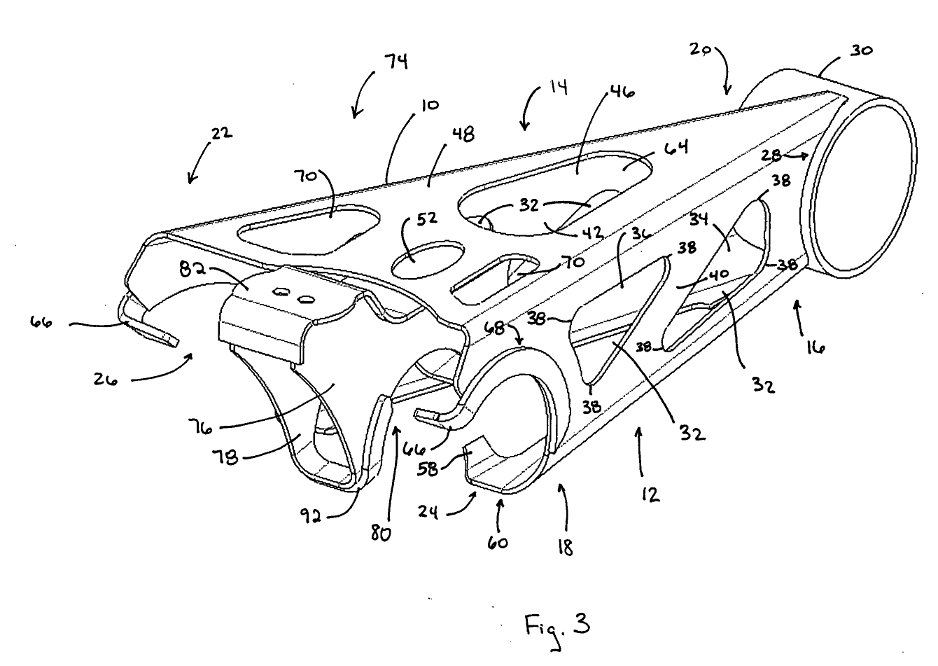

Looking now at FIGS. 3, 4 and 5, alternative embodiments of the trailing arm 10 described above is depicted. Reference numbers corresponding to like features depicted in FIGS. 1 and 2 will be used in FIGS. 3, 4 and 5.

As shown in FIG. 3, the trailing arm 10 is of a one-piece construction. The upper portion 48 is substantially planer and it is defined by the at least one suspension aperture 64 described above and the weld aperture 52 also described above.

Additionally, apertures 70 are located in the upper portion 48 of the trailing arm 10. Preferably, the apertures 70 are located adjacent the weld aperture 52. The apertures 70 are specifically located to reduce the stress experienced by the trailing arm 10 in that area.

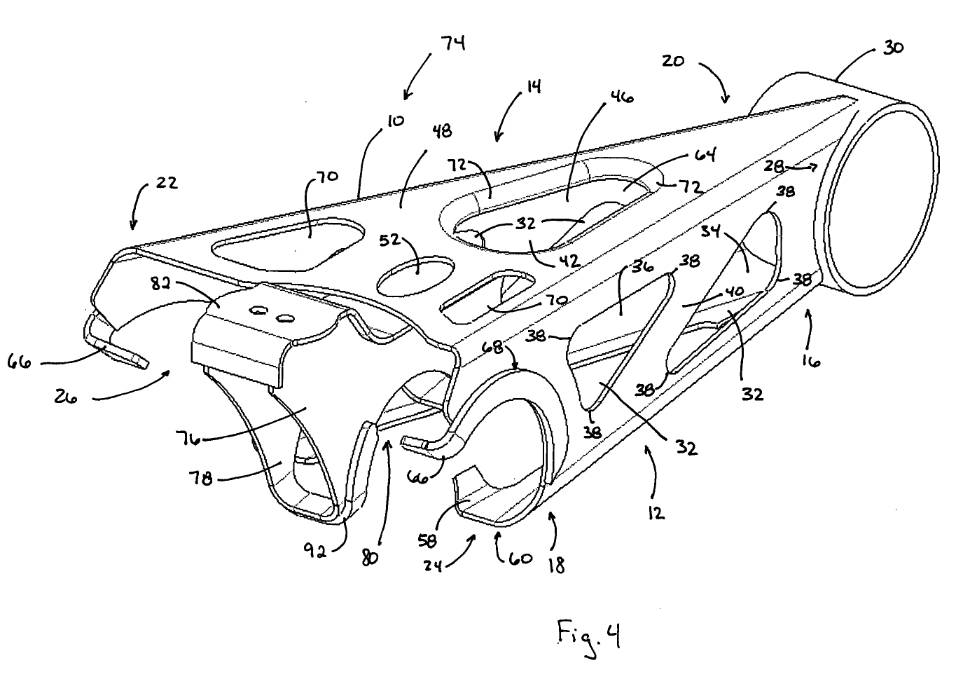

FIG. 4 depicts an alternative embodiment of the invention depicted in FIG. 3. Specifically, FIG. 4 shows the edges of the suspension aperture 64 in the upper portion 48 rolled to form a return 72 that extends inwardly to the interior portion 46 of the trailing arm 10. Those skilled in the art will appreciate that the return 72 adds high strength, stiffness and thus durability to the arm 10.

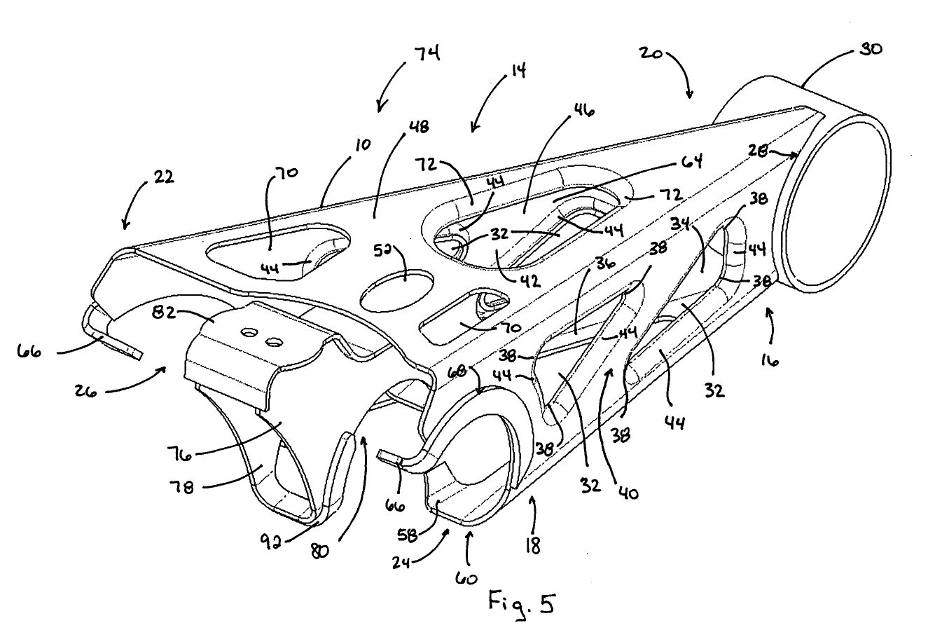

FIG. 5 depicts yet another embodiment wherein the edges of the apertures 32 in the side portions 12, 14 have been rolled to form a return 44 that extends inwardly to the interior portion 46 of the trailing arm 10. FIG. 5 also depicts the return 72 on the suspension aperture 64. Those skilled in the art will appreciate that the returns 44, 72 add high strength, stiffness and thus durability to the arm 10. Of course, the present invention also includes providing returns 44 on the apertures 32 in the side portions 12, 14 and no return on the suspension aperture 64.

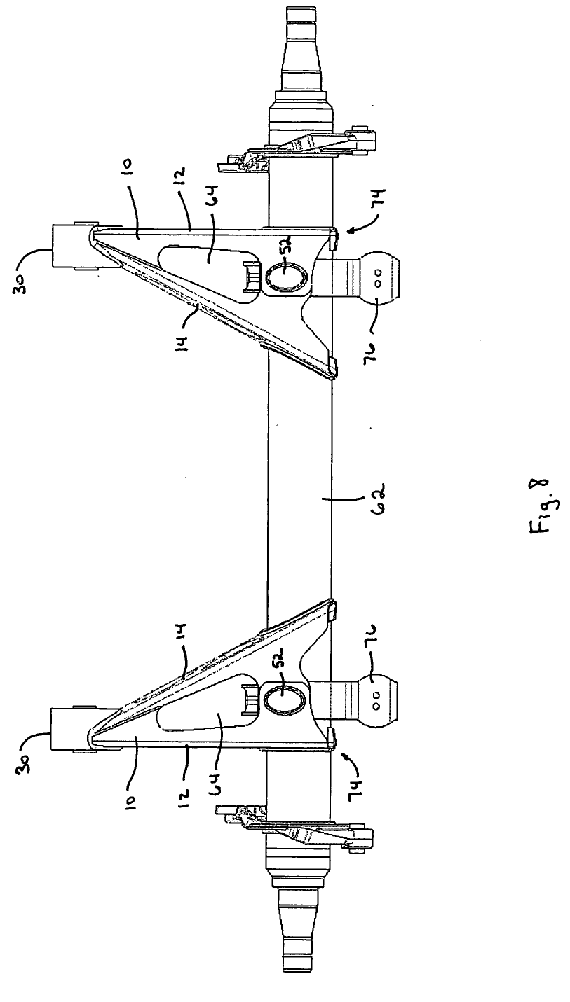

As best seen in FIG. 8, the embodiment of the trailing arm 10 characterized by overlapping first and second side portions 12, 14 has the first side portion 12 in a substantially perpendicular orientation with the axle 62. The second side portion 14 is in a non-perpendicular orientation with the axle 62. As shown in FIG. 8, the trailing arm 10 has a wide dimension where it connects with the axle 62. The trailing arm 10 tapers to the pivot connection 30.

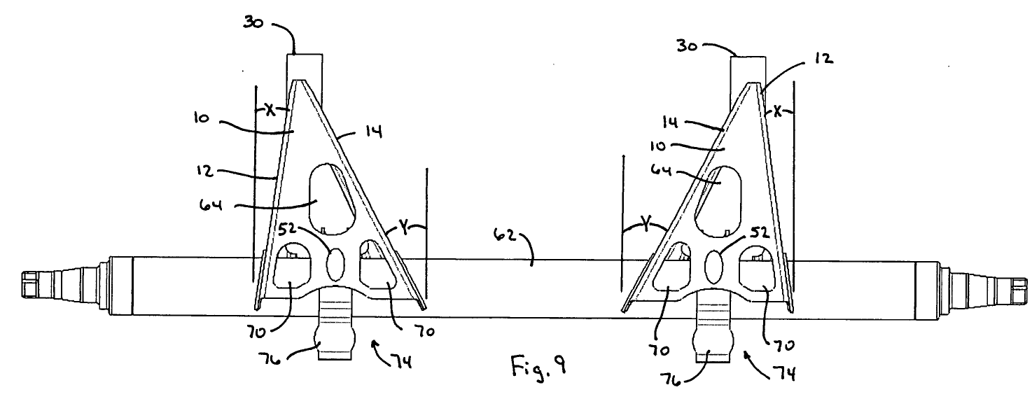

An alternative embodiment depicted in FIG. 9, the trailing arm 10 characterized by a one-piece construction has the first side portion 12 extending at a taper angle X from the axle 62 and the second side portion 14 also extending at a taper angle Y from the axle 62. As seen in FIG. 9, the second side portion 14 has a taper angle Y greater than the taper angle X of the first side portion 12. The taper angles X, Y of the first side portion 12 and the second side portion 14 cause the trailing arm 10 to taper to the pivot connection 30.

The trailing arm 10 is preferably constructed of a high strength metal, such as steel, however, other high strength metals known to those skilled in the art may also be used.

The trailing arms 10 described above are preferably part of a trailing arm assembly 74 also comprising a saddle bracket 76. The saddle bracket 76 is preferably constructed of metal, such as high strength steel, although other materials known to those skilled in the art may also be used. It is also preferred that the saddle bracket 76 have a substantially hollow interior portion 78.

A preferred embodiment of the saddle bracket 76 is depicted in all of the figures. Regardless of the embodiment of the trailing arm 10, the same saddle bracket 76 can be used interchangeably.

As can be seen in the figures, the saddle bracket 76 preferably has an axle recess 80 which provides the saddle bracket 76 with a complementary shape to the axle 62. It is also preferred that the saddle bracket 76 fit at least partially within the hollow interior portion 38 of the trailing arm 10.

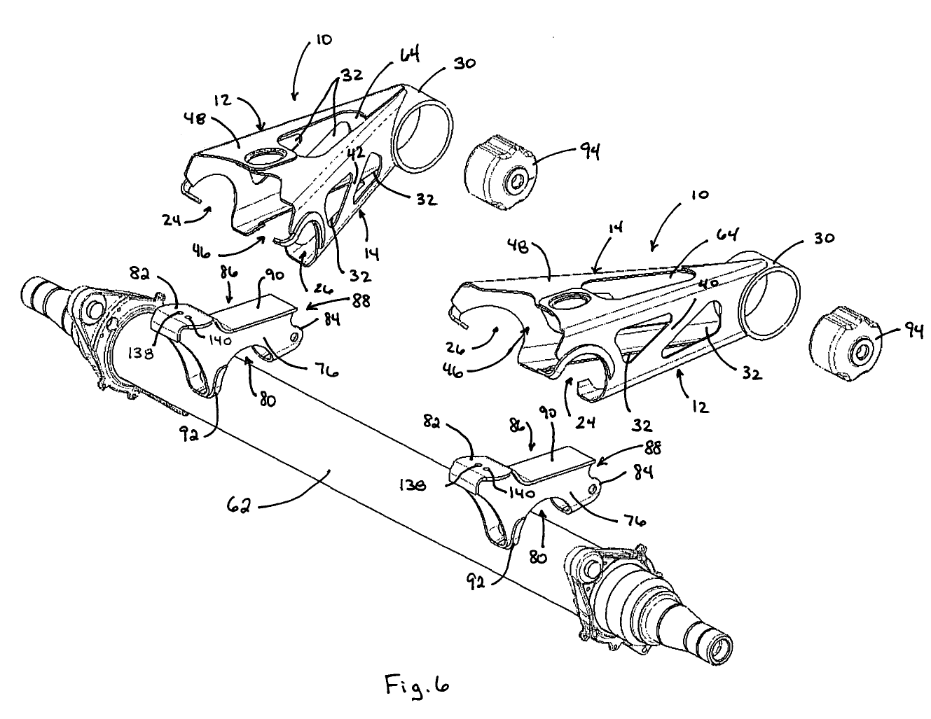

The saddle bracket 76 has an air spring attachment surface 82 and a shock absorber attachment surface 84. Preferably, the air spring attachment surface 82 is located on an upper portion 86 of the saddle bracket 76 and the shock absorber attachment surface 84 is located on a forward portion 88 of the saddle bracket 76, as best seen in FIG. 6.

The saddle bracket 76 also has a weldment surface 90. The weldment surface 90 is preferably located between the air spring attachment surface 82 and the shock absorber attachment surface 84. More preferably, the weldment surface 90 is located between the air spring attachment surface 82 and the shock absorber attachment surface 84 on the upper portion 86 of the saddle bracket 76.

As shown in FIGS. 1-7, the saddle bracket 76 preferably has a reinforcement plate 92.

Referring now to FIG. 6, a view of the axle 62, two saddle brackets 76 and two trailing arms 10 are depicted in an exploded orientation. A bushing 94 is also shown adjacent both of the pivot connections 30 of the trailing arms 10. Those skilled in the art will appreciate the bushings 94 are located within the pivot connections 30 of the trailing arm 10 by any known means.

The axle 62 may be a driven axle or a non-driven axle as both axle types are within the scope of the present invention.

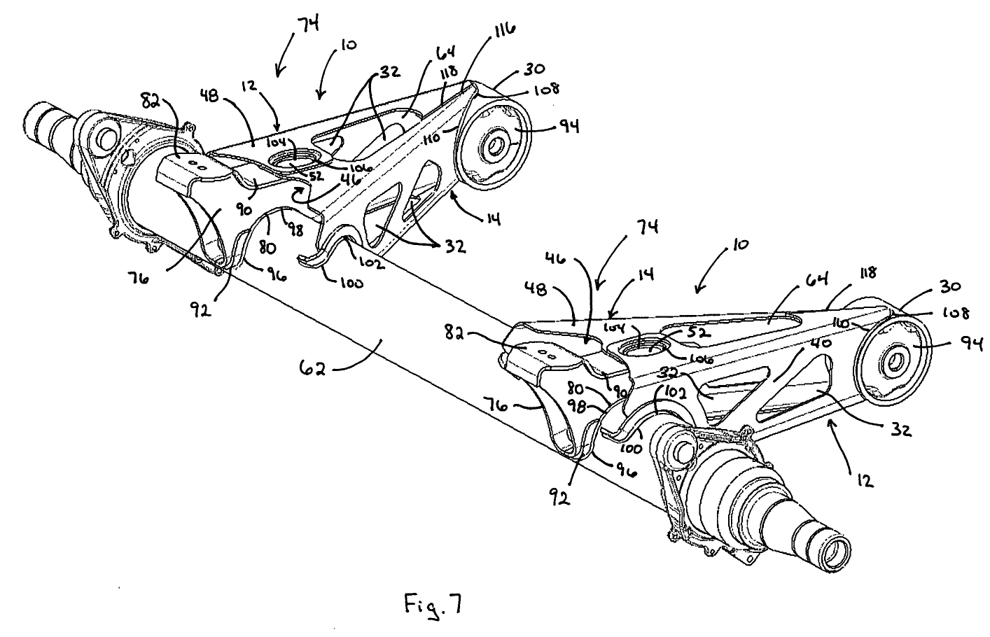

FIG. 7 depicts the two saddle brackets 76 and the two trailing arms 10 secured to the axle 62. The figures also depicts the bushings 94 now located in the pivot connections 36. As best shown in FIG. 7, the saddle brackets 76 are positioned on the axle 62 and welded thereto with a weldment 96 that preferably extends along an intersection 98 of the saddle brackets 76 with the axle 62. The weldment 96 may be continuous or non-continuous at the intersection 98.

The trailing arms 10 are located at least partially over the saddle brackets 76 so that the saddle brackets 76 extend at least partially into the interior portions 46 of the trailing arms 10. A weldment 100 is located at an intersection 102 of the trailing arms 10 with the axle 62. Preferably, the weldment 100 also secures the extension plate 66 of each trailing arm 10 to the axle 62 and the return 58 of each trailing arm 10 to the axle 62, as shown in FIG. 7. The weldment 100 may be continuous or non-continuous at the intersection 102.

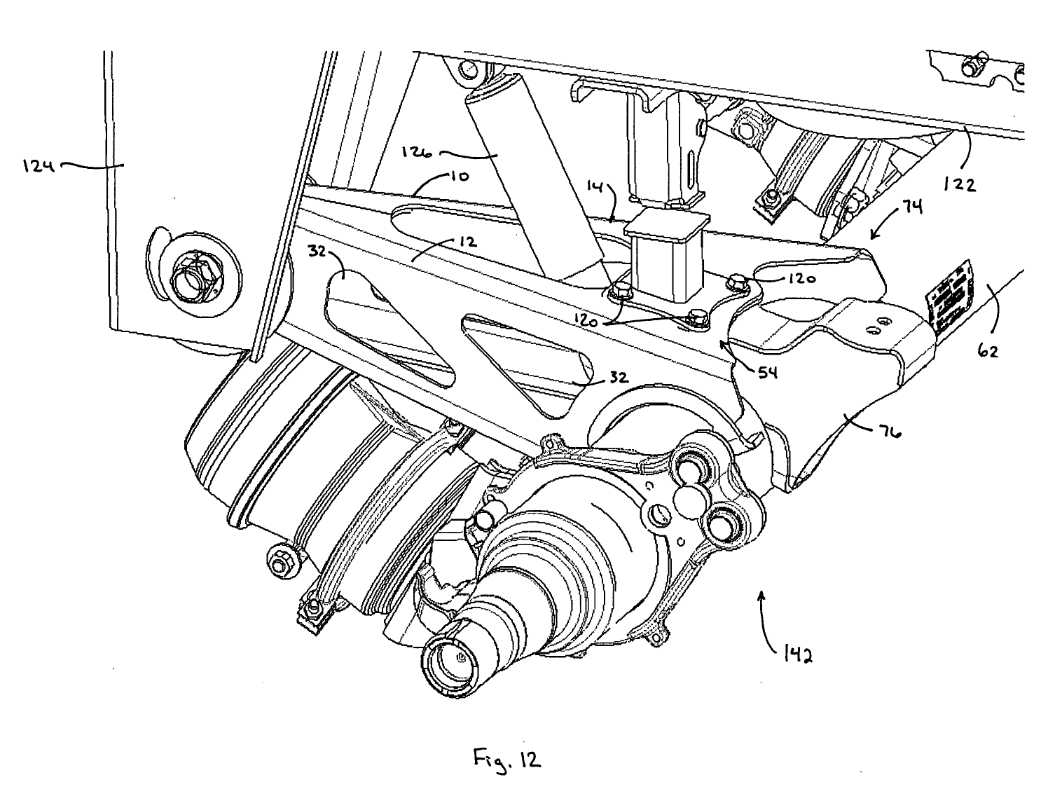

Those skilled in the art will appreciate that the weldments described above and hereinafter may be, by way of example, such as arc welds, stick welds, and/or resistance welds. The saddle brackets 76 may also be connected to the trailing arms 10 by bolts (as depicted in FIG. 12 and discussed below), such as nut and bolt combinations, Huck fasteners, rivets, stakes, pins, and/or they may be mechanically interlocked with one another, such as with a hook and tab.

When the saddle bracket 76 is installed on the axle 62 and the trailing arm 10 is installed on the axle 62, with the extension plates 66, the trailing arm assembly 74 encircles the axle 62 by approximately 250 degrees. Those skilled in the art will appreciate that it is within the scope of the present invention for the trailing arm assembly 74 to encircle more or less of the axle 62.

A weldment 104 is also located at an intersection 106 of the first side portion 12 and the second side portion 14, as shown in FIG. 7. Preferably, the weldment 104 is located on the inside of the weld aperture 52 formed by the first side portion 12 and the second side portion 14 to secure the side portions 12, 14 together. It is also preferred that this weldment 104 secures the trailing arm 10 to the weldment surface 90 of the saddle bracket 76.

A weldment 108 is also located along an intersection 110 of the trailing arm 10 with the pivot connection 30, as shown in FIG. 7. Additionally, a weldment 116 is located at an intersection 118 of the first side portion 12 and the second side portion 14 at the forward upper overlap portion 54. Referring now to FIG. 10, a weldment 112 is located along an intersection 114 of the side portions 12, 14 at the forward lower abutting portion 56.

Based on above-described preferred embodiment of the trailing arm 10, particularly considering the weld aperture 52 and the suspension aperture 64, a weldment running the full length of the trailing arm 10 from front to back is not required.

An alternative embodiment of the present invention is depicted in FIG. 12 wherein mechanical fasteners 120 are located through the forward upper overlap portion 54. The mechanical fasteners 120 secure the first side portion 12 and the second side portion 14 together. The mechanical fasteners 120 may be such as bolts and nuts, rivets, stakes, pins and/or be comprised of a mechanical interlock, such as hooks and tabs.

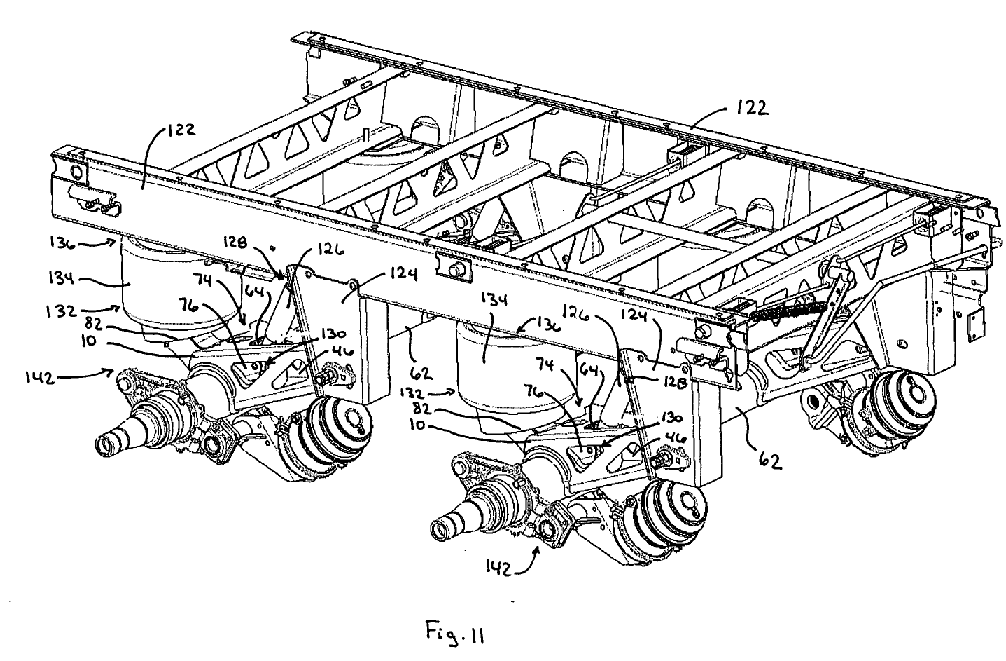

The trailing arm assembly 74, as described above, is attached to one or more vehicle frame members 122, as shown in FIG. 11. FIG. 11 depicts two trailing arm assemblies 74 of the present invention attached to the vehicle frame members 122. The attachment of just one trailing arm assembly 74 of the present invention will be described hereinafter to the frame members 122. It should be appreciated, however, that each trailing arm assembly 74 is secured to the frame members 122 in a substantially identical fashion.

The bushing 94, installed in the pivot connection 30 of the trailing arm 10, is pivotally secured to a complementary fitting (not shown) on a hanger bracket 124, as known by those skilled in the art. A shock absorber 126 is secured at one end 128 to the frame member 122. The other end 130 of the shock absorber 126 extends through the suspension aperture 64 of the trailing arm 10 into the interior portion 46 of the trailing arm 10. Preferably, this end 130 of the shock absorber 126 is secured to the shock absorber attachment surface 84 of the saddle bracket 76. The shock absorber 126 may be any shock absorber 126 known to those skilled in the art.

One end 132 of an air spring 134 is secured to the air spring attachment surface 82 of the saddle bracket 76. The other end 136 of the air spring 134 is attached to the frame member 122. The air spring 134 may be any air spring 134 known to those skilled in the art.

The air spring attachment surface 82 preferably has a left hole 138 and a right hole 140, as shown in FIG. 6. The right hole 140 of the left-most saddle bracket 76 is designed to only receive the left air spring 134 and the left hole 138 of the right-most saddle bracket 76 is only designed to receive the right air spring 134. Those skilled in the art will appreciate that other attachment methods and apparatus are within the scope of the present invention.

Referring back to FIG. 11, the trailing arm assembly 74 attached to the vehicle frame 122 as described above thus becomes a suspension system 142 for the vehicle. The saddle bracket 76 isolates vertical loads from both the shock absorber 126 and the air spring 134 directly into the axle 62, rather than into the trailing arm 10. Additionally, the vertical rearward force generated by the air spring 134 is partially cancelled by the vertical force generated by the shock absorber 126 on the forward side of the axle 62.

The trailing arm assembly 74 also allows the shock absorber 126 to be located further outboard on the vehicle frame 122 than the prior art shock absorbers. Locating the shock absorber 126 as described above provides better roll stability to the vehicle and puts the shock absorber attachment surface 84 in double shear.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A trailing arm, comprising:
a first side portion having an axle recess at one end;
a second side portion having an axle recess at one end; and
an upper portion defined at least partially by overlapping portions of said first side portion and said second side portion, wherein said upper portion has a suspension aperture therethrough.

2. The trailing arm of claim 1, wherein said first side portion and said second side portion define a substantially hollow interior portion between them.

3. The trailing arm of claim 1, wherein said overlapping portions of said first side portion and said second side portion define a weld aperture in said upper portion.

4. The trailing arm of claim 1, wherein said first side portion and said second side portion each have at least one aperture and said at least one aperture has an inwardly extending return substantially about said aperture.

5. The trailing arm of claim 4, wherein said first side portion and said second side portion have two apertures each and each of said apertures are substantially triangular in shape.

6. The trailing arm of claim 5, wherein one of said triangular-shaped apertures in said first side portion and one of said triangular-shaped apertures in said second side portion both have internal angles A, B and C where one or more of angles A, B or C are not equal to one another.

7. The trailing are of claim 5, wherein one of said triangular-shaped apertures in said first side portion and one of said triangular-shaped apertures in said second side portion both have internal angles D, E and F and where one or more angles D, E or F are not equal to one another.

8. The trailing arm of claim 1, wherein said suspension aperture is substantially triangular in shape.

9. The trailing arm of claim 1, wherein at least one of said first side portion or said second side portion has an extension plate located on an upper portion of said axle recess.

10. The trailing arm of claim 2, wherein at least one of said first side portion or said second side portion has a return located on a lower portion of said axle recess, said return extending into said interior portion.

11. The trailing arm of claim 2, wherein a saddle bracket having an axle recess is located in said interior portion, said saddle bracket having an air spring attachment surface and a shock absorber attachment surface.

12. A trailing arm assembly, comprising:
a trailing arm having a first side portion, a second side portion and an upper portion, said upper portion defined by said first side portion and said second side portion, wherein said upper portion has a suspension aperture; and
a saddle bracket at least partially located within said trailing arm and secured thereto, said saddle bracket having an axle recess and a suspension mounting surface wherein said suspension mounting surface is aligned with said suspension aperture.

13. The trailing arm assembly of claim 12, wherein said trailing arm has a curvilinear axle recess at one end thereof and a pivot connection at said other end.

14. The trailing arm assembly of claim 12, wherein first side portion and said second side portion both have apertures, said apertures of said first side portion and said second side portion have inwardly extending returns.

15. The trailing arm assembly of claim 13, wherein at least one of said first side portion or said second side portion has an extension plate located on an upper portion of said trailing arm axle recess and one of said first side portion or said second side portion has a return located on a lower portion of said trailing arm axle recess.

16. A suspension system, comprising:
an axle;
a trailing arm having a substantially hollow interior portion, a first end portion and a second end portion, said first end portion defined by an axle recess having a complementary shape to at least a portion of said axle and said second end portion having a pivot connection; and
a saddle bracket located adjacent said first end portion and at least partially within said hollow interior portion of said trailing arm, said saddle bracket having a complementary shape to at least a portion of said axle.

17. The suspension system of claim 16, wherein said trailing arm has a weld aperture and a weldment in said weld aperture for securing a first side portion and a second side portion of said trailing arm together and for securing said trailing arm to said saddle bracket.

18. The suspension system of claim 16, wherein at least one shock absorber is located through a suspension aperture in an upper portion of said trailing arm, said shock absorber being attached to said saddle bracket.

19. The suspension system of claim 17, wherein an air spring is attached at one end to a frame member and at the other end to said saddle bracket.

20. The trailing arm of claim 1, wherein said suspension aperture separates said upper portion and prevents a weldment from extending the full length of said upper portion.

21. The trailing arm of claim 1, wherein said first side portion has a diagonal separating a first aperture and a second aperture and said second side portion has a diagonal separating a third aperture and a fourth aperture.

22. The trailing arm of claim 1, wherein the angle at which said first side portion extends from an axle is different from the angle at which said second side portion extends from said axle.

23. The suspension system of claim 16, wherein said first side portion and said second side portion are secured together with mechanical fasteners.
